(19) United States
(12) Patent Application Publication
(10) Pub. No.: US 2004/0177240 A1
(43) Pub. Date: Sep. 9, 2004

(54) Data processing system having built-in memory in micro-processor

(75) Inventor: Pachinco Yang, HsinChu (TW)

Correspondence Address: TROXELL LAW OFFICE PLLC, SUITE 1404, 5205 LEESBURG PIKE, FALLS CHURCH, VA, 22041, US

(73) Assignee: Novatek Microelectronic Co.

(21) Appl. No.: 10/648,198

(22) Filed: Aug. 27, 2003

(30) Foreign Application Priority Data
Mar. 7, 2003 (CN) 092105039

(51) Int. Cl. G06F 15/177

(52) U.S. Cl. 713/1

(57) ABSTRACT

The present invention is a data processing system, which comprises a microprocessor. The microprocessor comprises a central processing unit (CPU) and a built-in non-volatile program memory for storing a startup program. The system further comprises a volatile memory, a permanent memory for storing an application program permanently, a bus connected to the microprocessor, the volatile memory and the permanent memory, and a power supply for providing power to the data processing system. While the switch of the power supply is turned on, the startup program stored in the non-volatile program memory is initialized first to transmit the application program stored in the permanent memory to the volatile memory via the bus, so that the CPU only needs to call and execute the application program in the volatile memory, instead of the permanent memory, and doesn't need to read the permanent memory repeatedly to avoid reducing the system efficiency.

### BACKGROUND OF THE INVENTION

1. Field of the Invention

The present invention relates to a data processing system in a microprocessor, especially suitable for portable digital storage players.

2. Description of the Prior Art

Portable digital storage players, such as digital still camera (DSC), digital video camera (DVC), digital voice recorder, and MPEG Audio Layer-3 (MP3) player, have the characteristics of being small and light weight yet having high storage capacity, so it is very convenient to be used. Therefore, the portable digital storage player is more and more popular and available in the market, and the competition of different brands is also more vigorous. For manufacturers, more functions and higher productivity yet lower cost are necessary to make the products more competitive.

The biggest difference between the microprocessor system of the portable digital storage player and the microprocessor of the personal computer (PC) is that the system of the portable digital storage player needs a solid state permanent memory. For DSC, this memory is used for storing photos; for DVC, this memory is used for storing films; for digital voice recorder, this memory is used for storing digitized speech; for MP3 player, this memory is used for storing songs in MP3 format.

Please refer to FIG. 1. FIG. 1 is a function block diagram of a data processing system 2 of the prior art. The data processing system 2 can be applied to portable digital storage players, such as DSC, DVC, digital voice recorder, and MP3 player. The data processing system 2 comprises a power supply 10, a microprocessor 20, a non-volatile program memory 50, a permanent memory 60, and a bus 80. The data processing system 2 further comprises a built-in volatile memory 40 inside the microprocessor 20, a central processing unit (CPU) 30, and an application program 70 stored in the non-volatile program memory 50. The bus 80 is used for connecting the microprocessor 20, the volatile memory 40, the non-volatile program memory 50, and the permanent memory 60.

The power supply 10 comprises a switch 11 and provides power to the data processing system 2 to maintain normal operation of the system. The non-volatile program memory 50 can store the application program 70 permanently, and the application program 70 doesn't vanish even if the power supply 10 is turned off. The volatile memory 40 is used for temporarily storing the data generated by the CPU 30, and if the power supply 10 is turned off, the temporary data vanishes. In the data processing system 2, the volatile memory 40 is inside the microprocessor 20. However, in other embodiments, the volatile memory 40 can be outside the microprocessor 20. The permanent memory 60 is provided for the CPU 30 to access data, and the data are kept even if the power supply 10 is turned off. The CPU 30 is used for executing programs or calculating data. The CPU 30 reads and executes the application program 70 stored in the non-volatile program memory 50 via the bus 80. And the CPU 30 stores the temporary data generated by executing the application program 70 in the volatile memory 40 via the bus 80.

In the digital storage player of the prior art, the microprocessor needs an external non-volatile program memory to store the specific application program. The specific application program is provided for the CPU to execute and achieve the objectives of taking pictures, recording sound, or playing MP3. The unit cost (dollars/byte) of the non-volatile program memory is higher than the permanent memory. If the application program can be stored in the permanent memory, the cost will be reduced a lot. However, it is a complicated process for the CPU to access the permanent memory. If the application program is stored in the permanent memory, the time of the CPU to access the permanent memory will be longer than to access the non-volatile program memory, and the system efficiency is reduced a lot. Therefore, a method is necessary for saving the cost of the non-volatile program memory and not reducing the system efficiency at the same time.

### SUMMARY OF THE INVENTION

The objective of the present invention is to provide a data processing system, in which the microprocessor doesn't need an external non-volatile program memory in order to save the cost of the external non-volatile program memory and not reduce the system efficiency.

According to an embodiment of the present invention, the data processing system comprises a microprocessor, a volatile memory for storing programs or data temporarily, a permanent memory for storing an application program permanently, a bus connected to the microprocessor, the volatile memory, and the permanent memory for transmitting programs or data, and a power supply, which comprises a switch and provides power to the data processing system to maintain normal operation of the data processing system.

The microprocessor comprises a CPU for executing programs or calculating data and a built-in non-volatile program memory within the microprocessor for storing a startup program.

The volatile memory is a built-in static random access memory (SRAM) inside the microprocessor or an external dynamic random access memory (DRAM) outside the microprocessor.

While the switch of the power supply is turned on, the startup program stored in the on-chip non-volatile program memory is initialized first to load the application program from the permanent memory into the volatile memory via the bus, so that the CPU only needs to call and execute the application program in the volatile memory, instead of the permanent memory, and doesn't need to read the permanent memory repeatedly to avoid lowering system efficiency.

The advantage and spirit of the present invention may be understood by the following recitations together with the appended drawings.

### BRIEF DESCRIPTION OF THE APPENDED DRAWINGS

FIG. 1 is a function block diagram of a data processing system of the prior art.

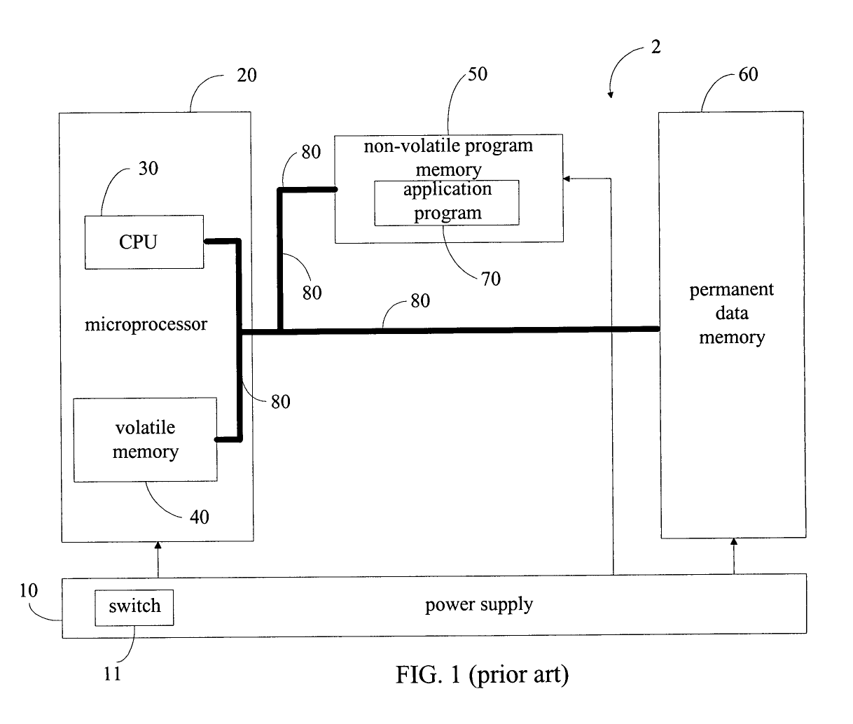

FIG. 2 is a function block diagram of a data processing system before power-on according to the present invention.

FIG. 3 is a function block diagram of a data processing system after power-on according to the present invention.

FIG. 4 is a function block diagram of a data processing system of another embodiment according to the present invention.

FIG. 5 is a data diagram of the needed time that a CPU randomly reads one byte data from different types of memory.

### DETAILED DESCRIPTION OF THE INVENTION

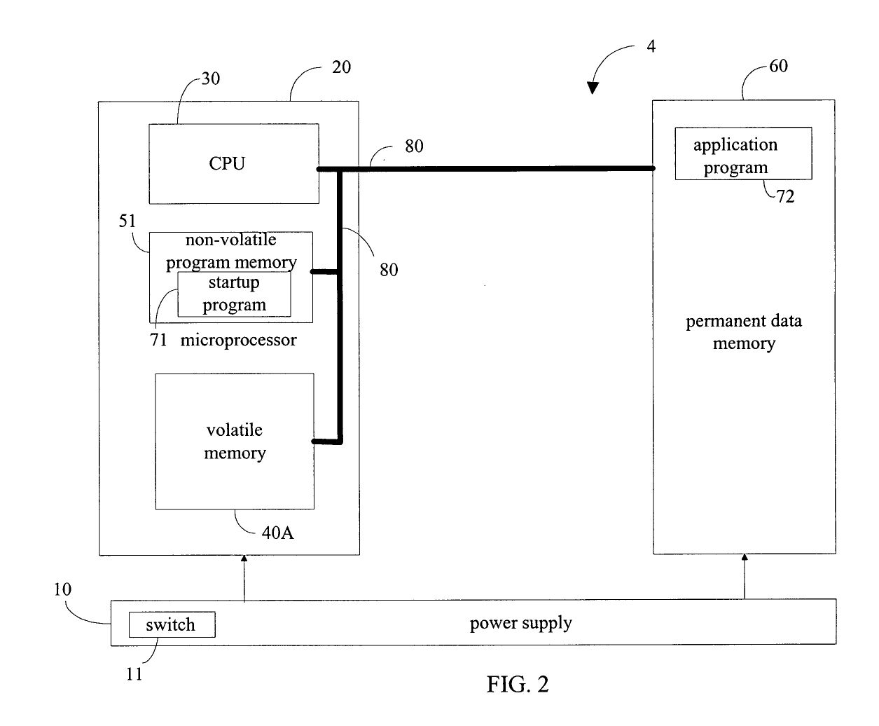

Please refer to FIG. 2. FIG. 2 is a function block diagram of a data processing system 4 before power-on according the present invention. The data processing system 4 can be applied to a digital still camera (DSC), a digital video camera (DVC), a digital voice recorder, an MP3 player, or some similar digital storage players. The data processing system 4 comprises a power supply 10, a microprocessor 20, a built-in volatile memory 40A inside the microprocessor 20, a permanent memory 60, and a bus 80.

The power supply 10 comprises a switch 11 and provides power to the data processing system 4 to maintain normal operation of the system. The volatile memory 40A is used for storing programs or data temporarily. The bus 80 connected to the microprocessor 20, the volatile memory 40A, and the permanent memory 60 is used for transmitting programs or data.

The microprocessor 20 further comprises a central processing unit (CPU) 30 for executing programs or calculating data and a built-in non-volatile program memory 51. The CPU 30 connects the permanent memory 60 and the volatile memory 40A via the bus 80.

The non-volatile program memory 51 is a mask ROM, a one-type programmable ROM, flash memory, a programmable logic array, or a hard-wired code table. A startup program 71 is stored in the non-volatile program memory 51, and the startup program 71 doesn't vanish even if the power supply 10 is turned off. The capacity of the non-volatile program memory 51 is 1K bytes.

The volatile memory 40A is used for temporarily storing the temporary data generated by the CPU 30, and if the power supply 10 is turned off, the temporary data vanishes. The data processing system 4 needs at least one volatile memory unit. In the data processing system 4 of this embodiment, the volatile memory 40A is a built-in static random access memory (SRAM) inside the microprocessor 20. And in another embodiment (not shown in the FIG.), the volatile memory can also be an external dynamic random access memory (DRAM) outside the microprocessor 20.

The permanent memory 60 is an external NAND type flash memory outside the microprocessor 20 for the CPU 30 to access data and for storing an application program 72. The data and application program 72 don't vanish even when the power supply 10 is turned off. The size of the application program 72 is between 32K and 1M bytes, and is larger than the capacity of the non-volatile program memory 51.

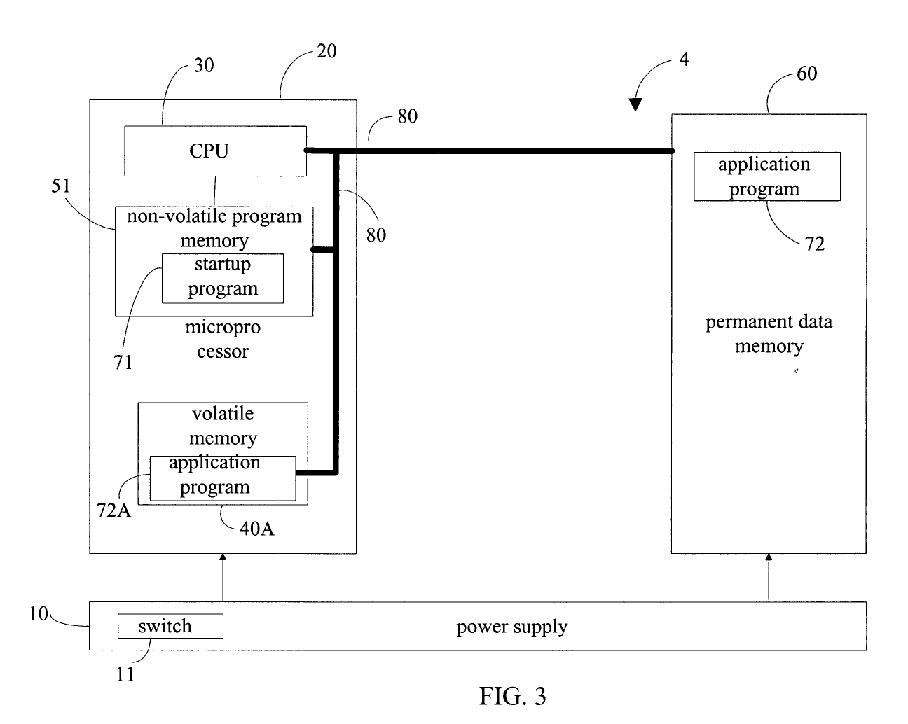

Please refer to FIG. 3. FIG. 3 is a function block diagram of the data processing system 4 after power-on according to the present invention. While the switch 11 of the power supply 10 is turned on, the startup program 71 stored in the non-volatile program memory 51 is initialized first to load the application program 72 from the permanent memory 60 into the volatile memory 40A via the bus 80, so that the CPU 30 only needs to call and execute the application program 72 in the volatile memory 40A, instead of the permanent memory 60.

While the switch 11 of the power supply 10 is turned off, the application program 72 stored in the volatile memory 40A vanishes. However the startup program 71 stored in the on-chip non-volatile program memory 51 and the application program 72 stored in the permanent memory 60 are kept.

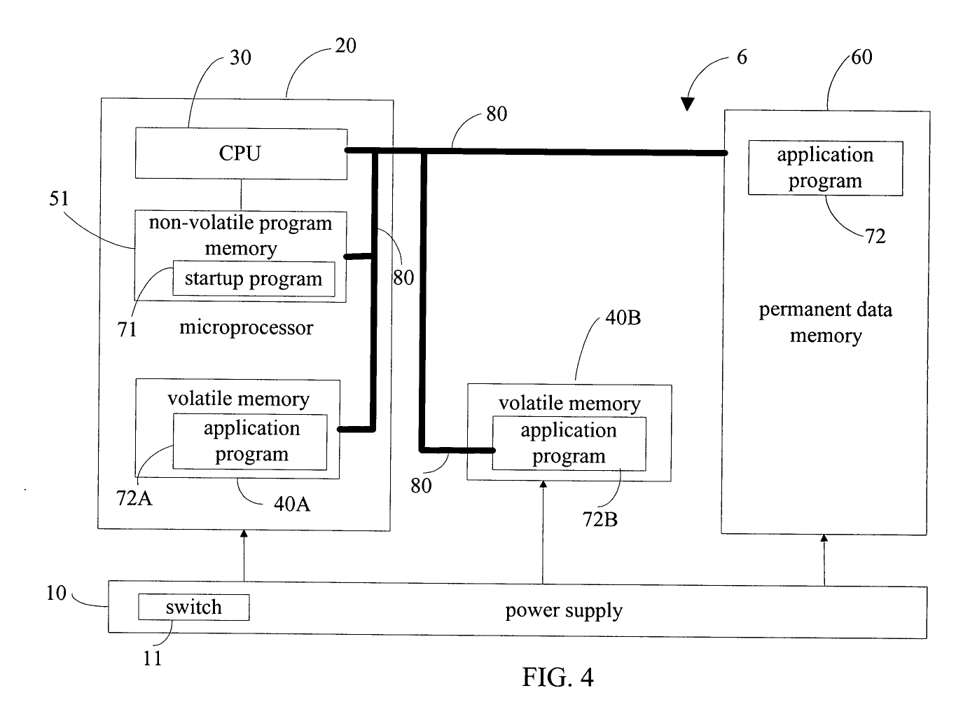

Please refer to FIG. 4. FIG. 4 is a function block diagram of a data processing system 6 of another embodiment according to the present invention. The main difference between the data processing system 6 and the data processing system 4 is that the data processing system 6 comprises two volatile memory 40A and 40B. The volatile memory 40A is a built-in static random access memory (SRAM) inside the microprocessor 20 while the volatile memory 40B is an external dynamic random access memory (DRAM) outside the microprocessor. The bus 80 connects the microprocessor 20, the volatile memory 40A, 40B, and the permanent memory 60. Other components and functions are similar as the above and will not be described again here.

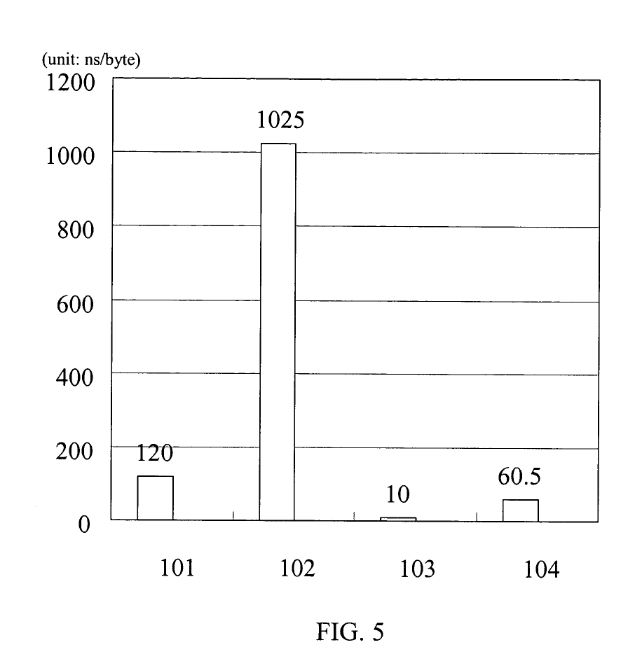

Please refer to FIG. 5. FIG. 5 is a data diagram of the needed time that a CPU randomly reads one byte data from different types of memory. As shown in FIG. 5, the unit of Y axis is ns/byte (nano second per byte), and X axis represents different conventional types of memory. The type of the non-volatile program memory 101 is MX27L5-12 EPROM; the type of the permanent memory 102 is K9S5608V0M-SB0 NAND-type flash-ROM; the type of the volatile memory 103 is K6R4008V1B-10 SRAM, and the type of the volatile memory 104 is K4S643232C-55 SDRAM.

As shown in FIG. 5, the needed time that the CPU reads the non-volatile program memory 101 is 120 ns for a byte in average; the needed time that the CPU reads the permanent memory 102 is 1025 ns for a byte in average; the needed time that the CPU reads the volatile memory 103 is 10 ns for a byte in average, and the needed time that the CPU reads the volatile memory 104 is 60.5 ns for a byte in average. According to the data of reading time, the speed that the CPU reads the volatile memory 103, 104 is the fastest; the speed that the CPU reads the non-volatile program memory 101 is second, and the speed that the CPU reads the permanent memory 102 is the slowest. According to the prior art, because the needed time that the CPU reads the permanent memory is quite long and the efficiency is lower, the application program is stored in the external non-volatile program memory outside the microprocessor, instead of being stored in the permanent memory. However, the unit cost of the external non-volatile program memory is higher. In other words, the cost of storing each byte data (dollars/byte) is higher correspondingly. In contrast, in the present invention, the non-volatile program memory is replaced by the permanent memory to store the application program, so the non-volatile program memory can be omitted. That is to say, for the designers and manufactures of products using microprocessors (such as digital still camera), the repeated cost that the non-volatile program memory causes can be eliminated, and the executing effect of the microprocessor is not reduced.

To compare with the prior art, the capacity of the built-in non-volatile program memory 51 inside the microprocessor is about 1K bytes in the present invention. The startup program 71 is stored in the non-volatile program memory 51, and the application program 72 is stored in the permanent memory 60, as shown in FIG. 2. While the switch 11 is turned on, the startup program 71 is initialized first to load the application program 72 from the permanent memory 60 into the volatile memory 40A via the bus 80 to be stored as the application program 72A, so that the CPU 30 only needs to call and execute the application program 72A in the volatile memory 40A, instead of the permanent memory, as shown in FIG. 3. Because the application program 72 is copied from the permanent memory 60 to the volatile memory via the bus 80 at starting, the CPU 30 doesn't need to read the application program 70 from the permanent memory 60. Therefore, this invention can save the cost of the non-volatile program memory and not reduce the system efficiency.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system comprising:
a microprocessor comprising:
a central processing unit (CPU) for executing programs or calculating data; and
a built-in non-volatile program memory within the microprocessor for storing a startup program;
a volatile memory for storing programs or data temporarily;
a permanent memory for storing an application program permanently;
a bus connected to the microprocessor, the volatile memory, and the permanent memory for transmitting programs or data; and
a power supply comprising a switch and providing power to the data processing system to maintain normal operation of the data processing system;
wherein, while the switch of the power supply is turned on, the startup program stored in the non-volatile program memory is initialized first to load the application program from the permanent memory into the volatile memory via the bus, so that the CPU only needs to call and execute the application program in the volatile memory, instead of the permanent memory.

2. The data processing system of claim 1, wherein the non-volatile program memory is a mask ROM.

3. The data processing system of claim 1, wherein the non-volatile program memory is a one-type programmable ROM, flash memory, a programmable logic array, or a hard-wired code table.

4. The data processing system of claim 1, wherein the capacity of the non-volatile program memory is 1K bytes.

5. The data processing system of claim 1, wherein the size of the application program is between 32K and 1M bytes, and is larger than the capacity of the non-volatile program memory.

6. The data processing system of claim 1, wherein the volatile memory is a built-in static random access memory (SRAM) inside the microprocessor.

7. The data processing system of claim 1, wherein the volatile memory is an external dynamic random access memory (DRAM) outside the microprocessor.

8. The data processing system of claim 1, wherein the volatile memory is used for temporarily storing the temporary data generated by the application program and the CPU.

9. The data processing system of claim 1, wherein the permanent memory is an external NAND type flash memory outside the microprocessor.

10. The data processing system of claim 6, the permanent memory is used for storing the application program and is provided for the CPU to access data.

11. The data processing system of claim 1, wherein the data processing system is a digital still camera (DSC).

12. The data processing system of claim 1, wherein the data processing system is a digital video camera (DVC).

13. The data processing system of claim 1, wherein the data processing system is a digital voice recorder.

14. The data processing system of claim 1, wherein the data processing system is an MP3 player.

15. The data processing system of claim 1, wherein while the switch of the power supply is turned off, the application program stored in the volatile memory vanishes; however, the startup program stored in the non-volatile program memory and the application program stored in the permanent memory are kept.

16. The data processing system of claim 1, wherein the data processing system does not comprise an external non-volatile program memory for storing the application program.
